(19) United States
(12) Patent Application Publication
(10) Pub. No.: US 2010/0149563 A1
(43) Pub. Date: Jun. 17, 2010

(54) IMAGE FORMING APPARATUS, PRINTING SUPPORT METHOD AND PRINTING SUPPORT PROGRAM

(75) Inventor: Tomoko OTOMARU, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/634,091

(22) Filed: Dec. 9, 2009

(30) Foreign Application Priority Data
Dec. 12, 2008 (JP) 2008-317049

(51) Int. Cl. H04N 1/60

(52) U.S. Cl. 358/1.9

(57) ABSTRACT

An image forming apparatus for printing image data of print subject after converting the image data to print image data dependent on an image forming device, the apparatus including a control section which converts the image data to first data in a color space independent from the image forming device by referring to a first conversion table, converts the print image data to second data in the color space by referring to a second conversion table, calculates a color difference specified by a difference between the first data and the second data, and causes a display section to display the calculated color difference.

### CROSS REFERENCE TO RELATED APPLICATION

The present application is based on Japanese Patent Application No. 2008-317049 filed with Japanese Patent Office on Dec. 12, 2008, the entire content of which is hereby incorporated by reference.

### BACKGROUND OF THE INVENTION

1. Field of Technology

The present invention relates to an image forming apparatus, a printing support method and a printing support program for a printing system including an image forming system.

2. Description of Prior Art

Printing apparatuses (herein after referred as image forming apparatus) including printers and digital multi-functional peripherals have been commonly utilized. The image forming apparatus, forms an image based on a print job sent from a computer terminal, forms an electrostatic latent image by irradiating a light beams on an electrostatically charged photosensitive material according to the image, develops the latent image by applying a charged toner to form a toner image, and transfers the toner image onto a sheet of paper via a transfer roller or a transfer member such as an intermediate transfer belt.

Materials such as the toner utilized in the image forming apparatus respectively have color characteristics, including the color characteristic which is easy or not easy for reproducing a specific color. Therefore, in cases of image formation, in order to reproduce the color of an original image with high fidelity as far as possible, predetermined image processing has been implemented by considering the color characteristics of the materials.

For example, Unexamined Japanese Patent Application Publication No. 2002-183634 discloses a color reproduction processing switching apparatus which automatically recognizes an image characteristics of a subject image, and switches to the most appropriate color reproduction processing (or color matching) system in accordance with the image characteristics. Further, Unexamined Japanese Patent Application Publication No. 2004-96444 discloses a color reproduction processing apparatus which performs hue emphasis to the image to be settled in a vision marginal domain. Furthermore, Unexamined Japanese Patent Application Publication No. 2005-27161 discloses a color reproduction processing apparatus which enables to immediately acknowledge the result of hue emphasis processing of the image (for example, saturated color etc.), and allows to adequately change the level of hue emphasis processing.

By the above described image processing, to reproduce the image close to the original image may be possible. However, each toner group composed of CMY or CMYK toners has a color domain of reproducible color (to be referred as reproducible color gamut), and in a cases where the original image contains a color beyond the reproducible color gamut, the image formation is performed by applying a color conversion to convert the color outside the reproducible color gamut into the color inside the reproducible color gamut. In these cases, the original image may not be reproduced in high fidelity.

Due to these backgrounds, in recent years, a toner group (referred as a “vivid toner”) which can reproduce a more bright color with high hue value than a conventionally used toner group (referred as a “normal toner”) is developed. By utilizing the image forming apparatus loading the vivid toner, the color outside the reproducible area of the normal toner can be more truly reproduced.

However, since the vivid toner is more expensive than the normal toner, the print cost may be increased by using the vivid toner, in cases where the original image is configured of reproducible color by both the vivid color and the normal color (the color within the reproducible color areas of both toners). Further, since the vivid toner reproduces bright colors, for example in a case of reproducing a deep color with low hue value, the normal toner may more truly reproduce the color.

Therefore, in order to achieve a high quality color reproduction with suppressing the print cost, it is required to select an appropriate image forming device by taking into consideration of each image characteristics and the reproducible color gamut of the image forming apparatus. Since an expert knowledge is required for selecting the appropriate image forming device, the selection of image forming device with good cost performance has been difficult for ordinary users, which being the problem.

The present invention has been performed in view of the above problem, and its main objective is to provide an image forming apparatus, a printing support method, and a printing support program thereof, which enable to easily select an image forming device with good cost performance.

### SUMMARY

An image forming apparatus, reflecting one aspect of the present invention to achieve the above object, for printing image data of print subject by converting the image data to print image data dependent on an image forming device, includes: a control section which converts the image data to first data in a color space independent from the image forming device by referring to a first conversion table, converts the print image data to second data in the color space by referring to a second conversion table, calculates a color difference specified by a difference between the first data and the second data, and causes a display section to display the calculated color difference.

A printing support method reflecting another aspect of the present invention for a printing system including an image forming apparatus which prints an image after converting image data of a print subject to print image data dependent on an image forming device, the method includes: a first step of converting the image data to first data in a color space independent from the image forming device by referring to a first conversion table; a second step of converting the print image data to second data in the color space by referring to a second conversion table, a third step of calculating a color difference specified by a difference between the first data and the second data, and a fourth step of displaying the calculated color difference on a display section provided at any of apparatuses composing the printing system.

A computer-readable storage medium, reflecting another aspect of the present invention, having a program stored therein for causing a computer to execute a printing support procedure for a printing system comprising an image forming apparatus which prints an image after converting image data of a print subject to print image data dependent on an image forming device, the printing support procedure includes: a first step of converting the image data to first data in a color space independent from the image forming device by referring to a first conversion table; a second step of converting the print image data to second data in the color space by referring to a second conversion table, a third step of calculating a color difference specified by a difference between the first data and the second data, and a fourth step of displaying the calculated color difference on a display section provided at any of apparatuses composing the printing system.

### BRIEF DESCRIPTION OF THE DRAWINGS

These and other objects, advantages and features of the invention will become apparent from the following description thereof taken in conjunction with the accompanying drawings in which:

FIG. 1 is a diagram showing a configuration example of a printing system relating to an embodiment of the present invention;

FIG. 2 is a block diagram showing a configuration of a computer terminal relating to an embodiment of the present invention;

FIGS. 3a-3b are diagrams showing a configuration of an image forming apparatus relating to an embodiment of the present invention, and FIG. 3a and FIG. 3b respectively show a schematic diagram and a block diagram;

FIG. 4 is a diagram showing a specific configuration of an image forming section relating to an embodiment of the present invention;

FIG. 5 is a flow chart diagram showing the operation of a control section of an image forming apparatus relating to an embodiment of the present invention;

FIG. 6 is a flow chart diagram showing a procedure of converting the image data to image data Lab, in the image forming apparatus relating to an embodiment of the present invention;

FIG. 7 is a flow chart diagram showing a procedure of converting the image data to print image data C′M′Y′K′, in the image forming apparatus relating to an embodiment of the present invention;

FIG. 8 is a flow chart diagram showing a procedure of displaying the color reproducibility, in the image forming apparatus relating to an embodiment of the present invention;

FIG. 9 is a flow chart diagram showing a procedure of thumbnail display, in the image forming apparatus relating to an embodiment of the present invention;

FIG. 10 is a flow chart diagram showing a procedure of enlarged display, in the image forming apparatus relating to an embodiment of the present invention;

FIG. 11 is a flow chart diagram showing a procedure of detailed display, in the image forming apparatus relating to an embodiment of the present invention;

FIG. 12 is a flow chart diagram showing a procedure of color space display, in the image forming apparatus relating to an embodiment of the present invention;

FIGS. 13a-13d are diagrams showing examples of thumbnail display screen to be displayed in a display section of the image forming apparatus relating to an embodiment of the present invention;

FIG. 14 is a diagram showing an example of a detailed display screen to be displayed in a display section of the image forming apparatus relating to an embodiment of the present invention;

FIGS. 15a-15b are diagrams showing an example of transition from a thumbnail display screen to an enlarged display screen to be displayed in a display section of the image forming apparatus relating to an embodiment of the present invention;

FIG. 16 is a diagram showing an example of a color space display screen to be displayed in a display section of the image forming apparatus relating to an embodiment of the present invention;

FIG. 17 is a diagram showing an example of a thumbnail display screen (in a case of two types of devices) to be displayed in a display section of the image forming apparatus relating to an embodiment of the present invention;

FIG. 18 is a diagram showing an example of a detailed display screen (in a case of two types of devices) to be displayed in a display section of the image forming apparatus relating to an embodiment of the present invention;

FIGS. 19a-19d are diagrams showing an example of transition from a thumbnail display screen to an enlarged display screen (in a case of two types of devices) to be displayed in a display section of the image forming apparatus relating to an embodiment of the present invention; and

FIG. 20 is a diagram showing an example of a color space display screen (in a case of two types of devices) to be displayed in a display section of the image forming apparatus relating to an embodiment of the present invention.

### DETAILED DESCRIPTION OF THE PREFERRED EMBODIMENT

As described in the description of prior art, the prior arts propose a color reproduction method and a hue enhancing method where the image color is converted to be settled in a prescribed color gamut. Since these methods are processing to image data, which do not take into consideration of a reproducible color gamut of print image data after image formation, it is not sure whether the color gamut of the image processing is settled in the reproducible color gamut of the image forming apparatus. Therefore, there has been a problem of difficulty in selecting a most appropriate image forming device to the image data.

In the present invention, by converting the image data of print subject into data of prescribed color space (for example, image data Lab) independent from an image forming device, also converting the print image data after image formation into the data of the prescribed color space (for example, print image data L′a′b′), calculating those difference ΔE, and by displaying the calculate color difference, it is enabled to confirm the color reproducibility.

Further, according to the present invention, not only a difference of color reproducibility due to a difference of image forming apparatus, but also a difference of color reproducibility due to a difference of image processing method can be displayed. Thus, confirmation of color reproducibility of the image data can be enabled, which is changed not only by the difference of a toner, but also by the combination of image processing method, image forming apparatus and the like. Therefore, a user can select the most appropriate image forming device among various image forming devices, according to an objective of the user.

### Embodiment

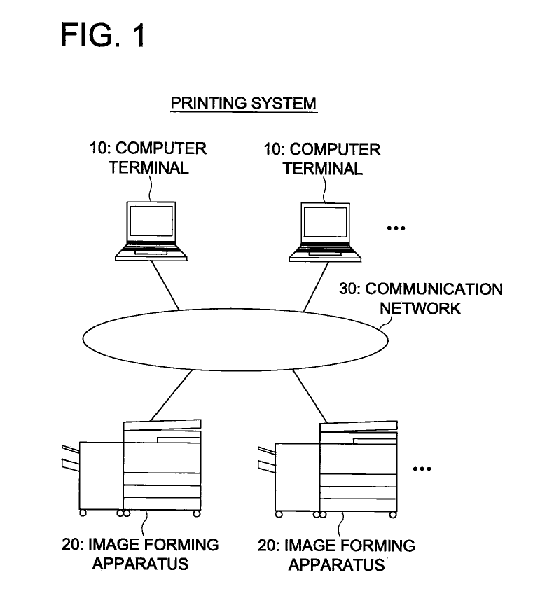

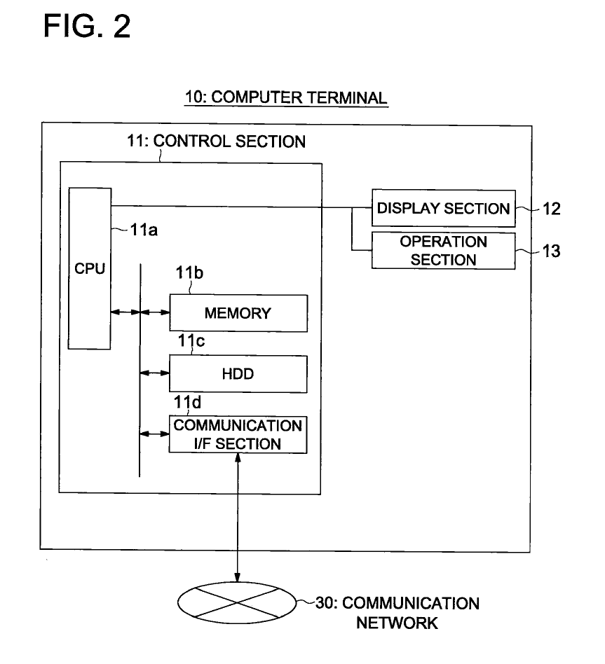

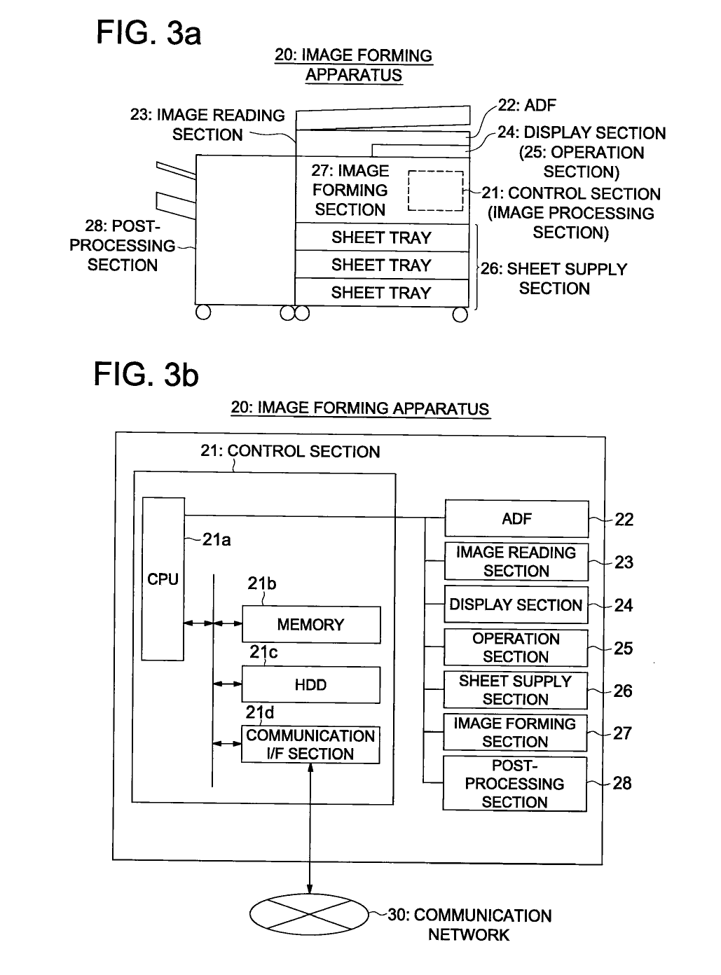

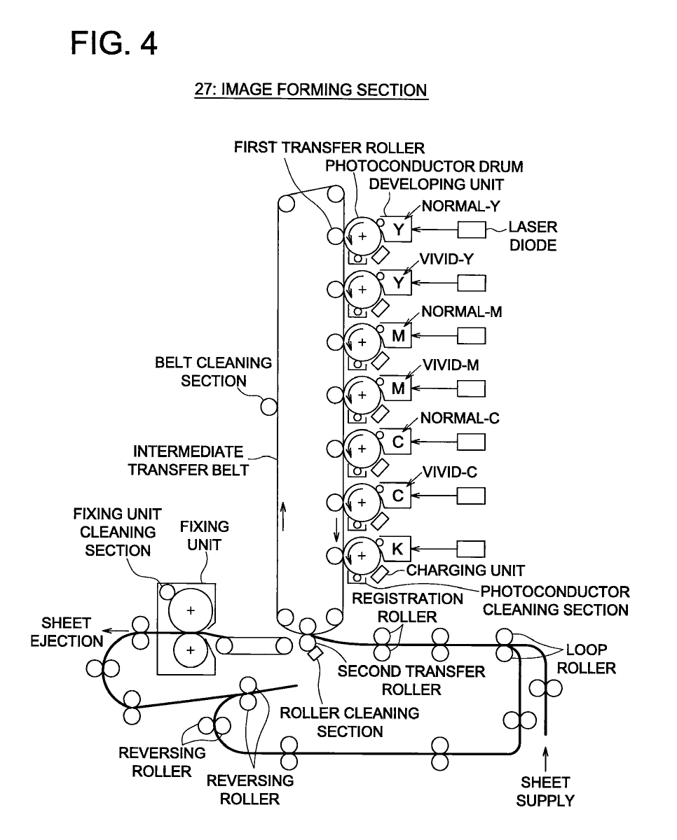

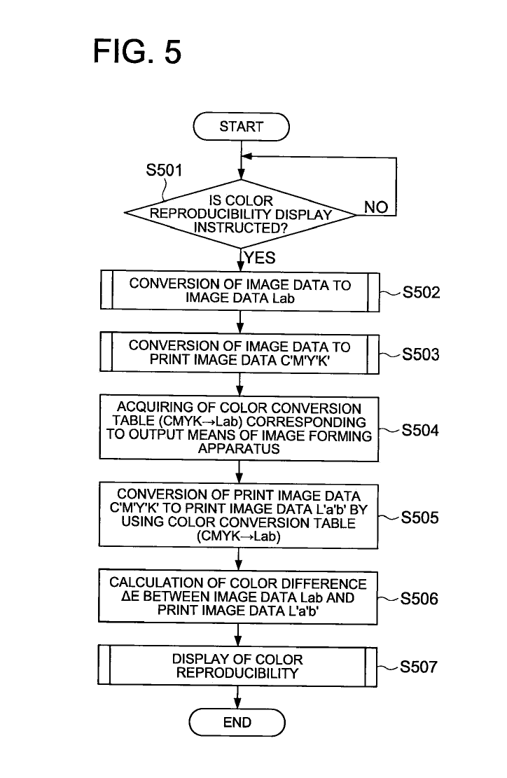

In Order to Describe One Embodiment of the Present invention in more detail, an image forming apparatus, a printing support method, and a printing support program thereof, relating to the embodiment of the present invention, will be described with reference to FIGS. 1-20. FIG. 1 is a diagram showing a configuration example of a printing system relating to an embodiment of the present invention; FIG. 2 shows a configuration of a computer terminal, FIGS. 3a-3b and FIG. 4 show a configuration of an image forming apparatus. FIGS. 5-13 are flow chart diagrams showing the operation of an image forming apparatus, and FIGS. 14-20 show examples of the screen displayed on the display section of the image forming apparatus.

As shown in FIG. 1, a printing system of the present embodiment is configured of one or more computer terminal 10 for transmitting and receiving a print job, and one or more image forming apparatus 20 for receiving the print job and executing the printing, and these are connected with communication network 30 of the LAN (Local Area Network) or the WAN (Wide Area Network) specified by standards such as ETHERNET (registered trade mark), Token Ring, FDDI (Fiber-Distributed Data Interface).

Further, as shown in FIG. 2, computer terminal 10 is configured of control section 11, display section 12, and operation section 13 and the like.

Control section 11 includes CPU (Central Processing Unit) 11a, memory 11b such as ROM (Read Only Memory), RAM (Random Access Memory), HDD (Hard Disk Drive) 11c, and communication I/F section lid and the like, and these are connected via bus. CPU 11A controls each section. Memory lib temporarily stores the various data read in from HDD 11c, or communication I/F section 11d, the stored data is processed by CPU 11a and is transferred to HDD 11c or communication I/F section 11d, as necessary. HDD 11c stores the program for CPU 11a to control each section, and the information relating to processable function of the apparatus and the print job, etc., which are read out as necessary and executed on memory 11b. Communication I/F section 11d establishes the connection between the apparatuses connected via communication network 30, and executes the data transmission and reception.

Control section 11 functions as an application to create a document, and as a printer driver to print the document. The document created by the application is converted to print job with a language {PDL(Page Description Language) such as PCL(Printer Control Language) and PS(Post Script)} which is readable by image forming apparatus 20, and transmitted to image forming apparatus via communication I/F section 11d.

Display section 12 is configured of a Liquid Crystal Display device (LCD), an Organic Electro Luminescence Display device, or the like, and display section 12 displays a printer driver screen and property screen for setting a print job to be sent to image forming apparatus 20.

Operation section 13 is a section for manipulating the information displayed on the display section 12, and inputting the information, and is configured of a pointing device, keyboard, trackball, track pad, tablet, stylus pen or the like.

As shown in FIG. 3, image forming apparatus 20 is configured of control section 21, ADF (Automatic document Feeder) 22, image reading section 23, display section 24, operation section 25, sheet supply section 26, image forming section 27, post-processing section 28, and the like.

Control section 21 controls each component section, and includes CPU21a, memory 21b such as ROM and RAM, Hdd21c, communication I/F section 21d, which being connected via a bus. CPU21a controls each section. Memory 21b temporarily stores various data read from HDD21c, image reading section 23, communication I/F section 21d. The temporarily stored data is applied image processing by CPU 21a, and transferred to HDD 21c and/or image forming section 27 as necessary. HDD21c stores a program for CPU 21a to control each section, information regarding the processable functions of the apparatus, a table for converting image data to the data capable of printing (hereinafter referred as print image data), a table for converting the image data and the print image data into data of prescribed color space, and a ICC (International Color Consortium) profile described below, etc. The data stored in HDD 21c is read out by CPU 21a as necessary, and executed on memory 21b. Communication I/F section 21d executes transmission and reception of data, by establishing the connection between devices connected via communication network 30.

Control section 21 also functions as a image processing section which creates image data by rasterizing each page of a print job, applies image processing and screening as necessary, and after that, converts to the print image data capable of printing at image forming section 27.

Further, control section 21 also functions as a printing support section which converts the image data of print subject to the data in a prescribed color space independent from the image forming apparatus (for example, image data Lab), converts the image data to the print image data (for example, print image data C′M′Y′K′), converts the print image data to the data of the prescribed color space (for example, print image data L′a′b′), and after that, calculates a color difference ΔE between those data, and provides the information for confirming the color reproducibility by displaying the color difference in a subscribed screen (thumbnail screen, detailed display screen, or color space display screen, which will be described later). Said printing support section can be structured as hardware, as a printing support program which allows a computer to function as the printing support section, or as a configuration in which control section 21 executes the printing support program.

ADF 22 is a section which automatically conveys a single or plural sheet of original documents to image reading section 23.

Image reading section 23 is for optically reading the image data from a document sheet on a platen, and is configured of a light source to scan the original, an image sensor such as CCD (Charge coupled Device) to convert the light reflected from the original to electrical signals, and an A/D converter to apply A/D conversion on the electrical signals, etc.

Display section 24 is configured of a LCD display device, an organic EL display device, or the like, and displays a screen for operating image forming apparatus 20 and a screen for displaying the color difference, etc. Operation section 25 is configured of such as buttons and switches for various setting and instructions. Display section 24 and operation section 25 may be either separate devices or a single bodied device where a pressure sensitive operation section 25 (touch panel) having transparent grid electrodes is provided on display section 24. In the case of touch panel, XY coordinates of the position pressed by a finger or a stylus is detected as voltage values, and the detected positional signal is outputted as an operation signal onto control section 21.

Sheet supply section 26 is configured of sheet trays accommodating various sized sheets of paper, and includes a section to convey the accommodated sheets to image forming section 27.

Image forming section 27 is configured of component elements necessary for an image forming process utilizing such as an electrophotographic system and an electrostatic recording system. Image forming section 27 forms an image on a specified sheet based on the image data read from image reading section 23 or the print job received via communication I/F section 21d, and send out to post-processing section 28.

Specifically, as shown in FIG. 4, image forming section 27 is configured of a writing unit with laser diode, a photoconductor unit, a transfer unit and the like. The writing unit is composed of such as a laser diode, and irradiates the laser beam to expose an image based on the print image data inputted from the image processing section. The photoconductor unit is configured of a photoconductor drum, a developing unit, a charging unit, a photoconductor cleaning section, and the like, and forms a toner image on the photoconductor drum with a toner supplied from the developing unit. Image forming section 27 is, for example, provided with seven photoconductor unit corresponding to seven colored toners including yellow (Y), magenta (M), and cyan (C) toners in a first toner group (normal toner in this group) of a prescribed reproducible color gamut, and yellow (Y), magenta (M), cyan (C), and black (B) toners in a second toner group (vivid toner in this group) of reproducible color gamut different from the prescribed color gamut. The transfer unit is configured of a first transfer roller, an intermediate transfer belt, a belt cleaning section, a second transfer roller, a roller cleaning section and the like, and transfers the toner image formed by the photoconductor unit onto the intermediate transfer belt, then transfers the toner image on the intermediate transfer belt onto a sheet of paper. The fixing unit is configured of a fixing device, a fixing unit cleaning device and the like, and fixes the toner image on the sheet of paper. The conveyance unit is configured of a sheet supply roller, a registration roller, a loop roller, a reversing roller, a sheet ejection roller and the like, and conveys a prescribed sheet from sheet supply section 26 to the second transfer roller, then ejects the sheet after fixing to post-processing section 28.

Post-processing section 28 applies finishing processing required by a user, to the sheet conveyed from image forming section 27, such as punching, stapling, and book binding based on the instruction from control section 21.

The configuration shown by FIGS. 1-4 is an example of the present embodiment. For example, in the configuration, image forming section 27 of image forming apparatus 20 is loaded with two types of toner group each different in reproducible color gamut, however, the configuration is possible where a plurality of image forming apparatuses each being loaded with a toner group of different reproducible color gamut is connected via network 30.

Further, although in the present embodiment, image forming apparatus 20 is configured to calculate and display the color difference, control section 11 of computer terminal 10 connected with image forming apparatus 20 may operate the printing support program and acquire the image data and the conversion table via communication network 30, convert the image data and the print image data into data of the same color space, calculate the color difference and display the color difference on a display section 12 of computer terminal 10, or transmit the screen data to another apparatus to display on the display section of the another apparatus.

Further, in FIG. 1, although the printing system is configured of computer terminal 10 and image forming apparatus 20, a control device such as a RIP (Raster Image Processor) controller to convert the image data into the print image data may be connected via communication network 30. Further said control device may operate the printing support program to convert the image data and the print image data into data of the same color space, calculate the color difference and display the color difference on a display section of the control device, or transmit the screen data to another apparatus to display on the display section of the another apparatus.

Next, the overall operation of image forming apparatus 20 having the above described configuration will be described.

In making copies, when an original document is placed on the original document platen of ADF 22 and copy start button is presses by a user, or in network printing, when a print job is received from communication network 30 via communication I/F section 21d of the image forming apparatus, image forming apparatus 20 feeds a sheet of paper from a specified sheet supply section 26.

Image data read by image reading section 23 in making copies, or print jobs received via communication I/F 21d in network printing, are generally referred as “print job”, here.

The print job is composed of print job information and image data including, for example, four color data of CMYK. The print job is temporarily stored in memory 21b, and converted, on memory 21b, to print image data capable of image formation on a print sheet. Various programs to convert the print job into the print image data capable of image formation on a print sheet are stored in HDD 21c, and a required program is readout by CPU 21a.

FIG. 5 shows a flow of comparing the image data and the print image data capable of image formation on a print sheet, after expressing both data in a common color space, and displaying the difference of color reproducibility. In FIG. 5, Lab is utilized as the common color space, any color space may be utilized if the image data and the print image data are commonly expressed as “Device Independent Color” in the color space.

In a case where the instruction of color reproducibility display is issued from operation section 13 of computer terminal 10 (S501: Yes), control section 21 (or printing support program) of image forming apparatus 20 utilizes a common color space for the image data instructed to display the color reproducibility and the print image data in the following procedure:

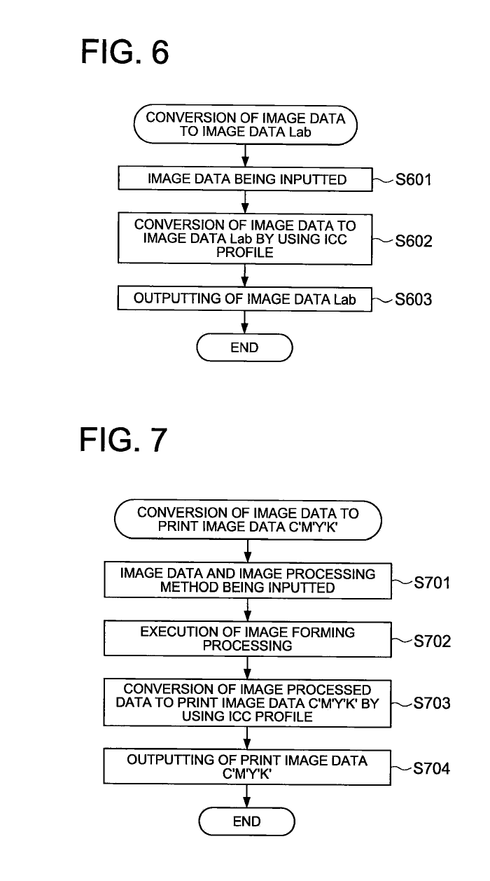

First, converting the image data to data expressed by Lab (L; lightness, a: green-red, b: blue-yellow) data on a color space (referred as image data Lab) (S502) by utilizing a first conversion table (ICC profile), the conversion process being shown in FIG. 6;

Next, converting the image data to the data (referred as print image data C′M′Y′K′) (S503), which is changed in format to be capable of image formation on a print sheet, the conversion process being shown in FIG. 7;

Next, acquiring a color conversion table (second conversion table) for converting the print image data C′M′Y′K′ to device dependent color (CMYK->Lab) (S504); Although, the color conversion table (CMYK->Lab) is required to be previously prepared for each outputting condition of the image forming apparatus, any type may be utilized if it is capable of converting the print image data to the device independent color common to the image data. In the case of FIG. 5, since the color space is standardized to Lab, the CMYK->Lab conversion table for converting the print image data C′M′Y′K′ to Lab values is required.

Next, by utilizing the second color conversion table (CMYK->Lab), converting the print image data C′M′Y′K′ to the data expressed by Lab values on the color space (referred as print image data L′a′b′) (S505);

Next, calculating color difference ΔE between the image data Lab and the print image data L′a′b′, both having been standardized in the device independent color according to the above procedure (S507); and

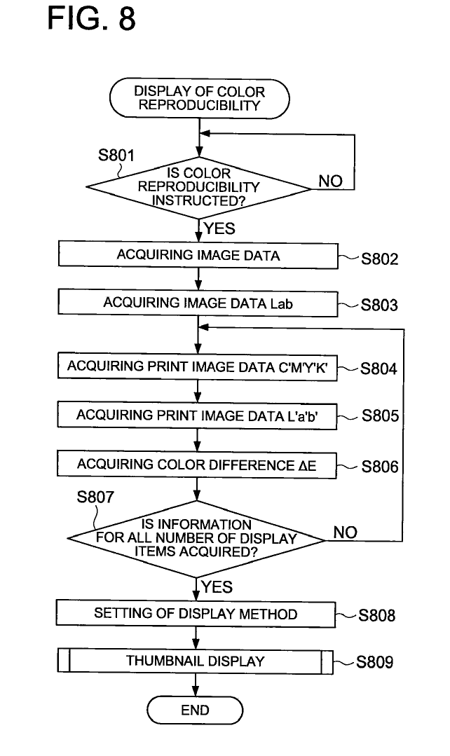

After that, displaying the difference of color reproducibility based on the color difference (S507). The flow chart for color reproducibility display is shown in FIG. 8.

In cases where color reproducibility of image forming apparatuses using Vivid toner and using Normal toner are to be compared, wherein image forming apparatuses are utilizing different image forming materials with each other, there may be a case where control section 21 cannot calculate the print image data C′M′Y′K′ or the print image data L′a′b′ of the other image forming apparatus. In such the case, the print image data C′M′Y′K′ or the print image data L′a′b′, which have been acquired from the other image forming apparatus by computer terminal 10, may be obtained via communication I/F section 21d of image forming apparatus 20.

Further, in the present embodiment shown is the case where the screen indicating the difference of the color reproducibility is displayed on display section of image forming apparatus 20, however, to make the screen usable at the computer terminal 10 may be also applicable.

Each processing will be described in detail below.

(CONVERSION of IMAGE DATA->IMAGE DATA Lab)

FIG. 6 shows the procedure to convert the image data to the image data Lab with utilizing ICC profile (a device profile describing color properties of each device) as the first conversion table.

The inputted image data (S601) is converted to the image data Lab by the use of ICC Profile (S602), and the result of the conversion is outputted (S603).

This profile conversion is executed to uniform the color spaces of the image data and the print image data to a device independent color. Here, the image data is converted to the image data Lab, however, any format is possible only if uniformity to a device independent color is attained.

(Conversion of Image Data->Print Image Data C′M′Y′K′)

FIG. 7 shows the procedure of converting the image data to the print image data C′M′Y′K′ capable of image formation on a print sheet according the image processing method.

Based on the image data and image processing method (S701), image forming processing is executed (S702). After that, by utilizing the ICC Profile, the data after image processing is converted to the print image data C′M′Y′K′ (S703), and the result of the conversion is returned (704).

Although this processing is assumed to be executed at image forming section 27, anywhere is possible only if the same output data is obtained as the print image data formed at image forming section 27. For example, such as RIP controller may execute this processing.

(Display of Color Reproducibility)

FIG. 8 shows the procedure of displaying the color reproducibility based on color difference.

In the case where display of color reproducibility is instructed (S801: Yes), acquired are image data necessary for displaying the original image, namely the image data (S802) and the image data Lab (S803).

Next, acquired are the print image data necessary for displaying the print image data, namely C′M′Y′K′(S804) and the print image data L′a′b′(S805), and acquired is ΔE (s806) which being necessary for displaying the difference of color reproducibility. Thus, the steps of S804-S806 are repeated until data for the number of display cases (the number of patterns of image forming device where the difference in color reproducibility from the original image is to be displayed) is obtained.

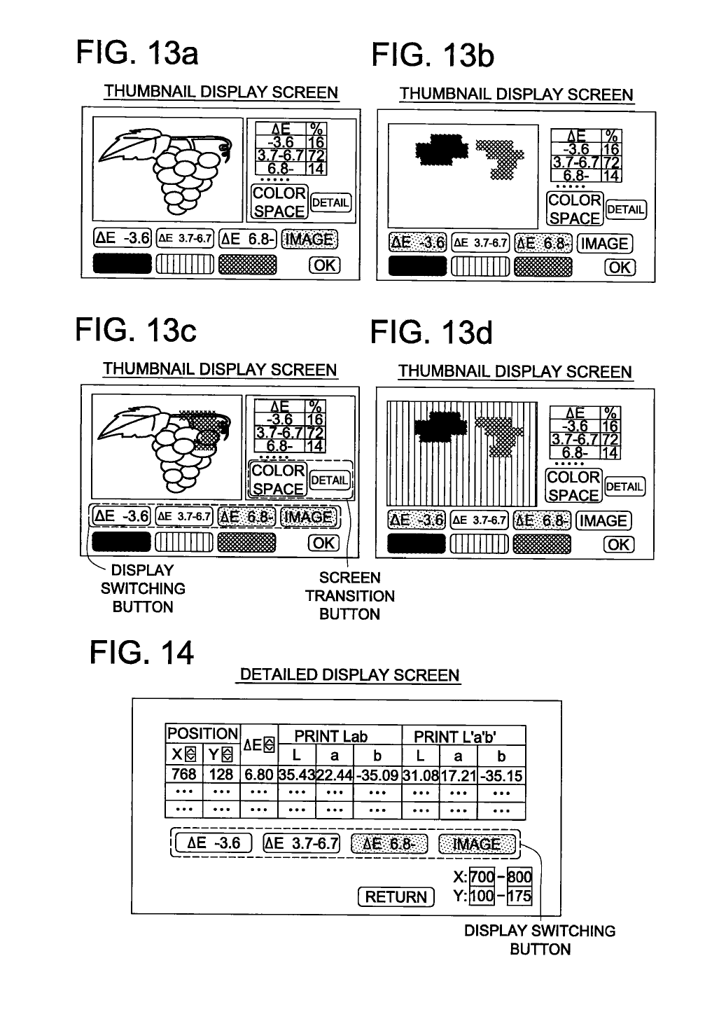

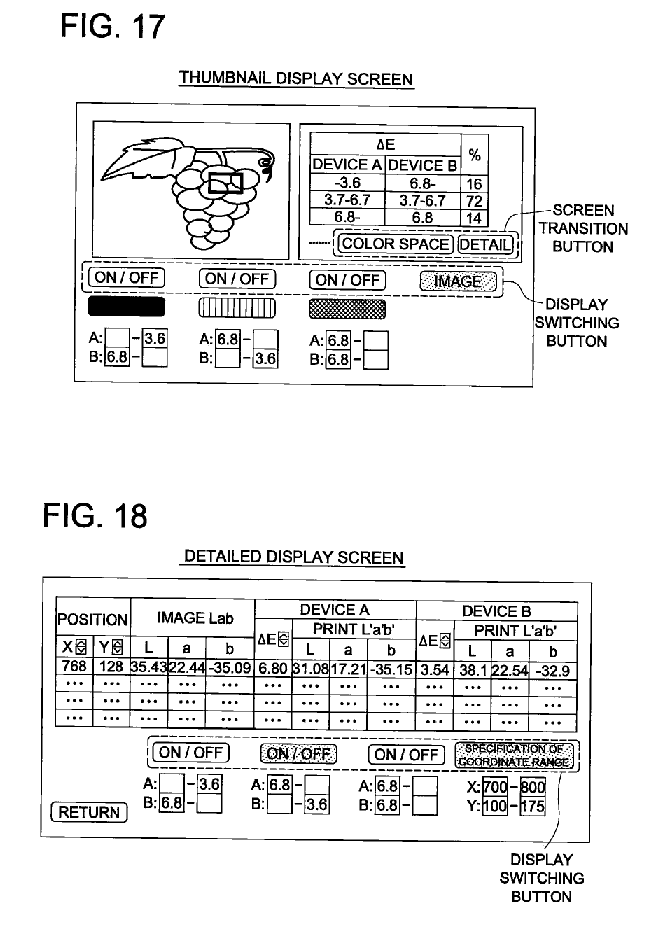

In the step of display method setting (S808), settings such as classification method and display method of color difference ΔE usable for all displays, setting for detailed display, and default coordinates setting for enlarged display. Those specific examples are shown below.

<SETTING REQUIRED FOR THUMBNAIL DISPLAY (FIGS. 13a-13d, and 17)>
Example of display setting for 3 patterns of color difference ΔE

Pattern 1: display with small dot hatching

Pattern 2: display with vertical line hatching

Pattern 3: display with diagonal lattice hatching.
Example of classification method setting for 3 patterns of color difference ΔE (in the case of color reproducibility setting of one device in FIG. 13a-d)

Pattern 1: displaying ΔE 3.6 or less

Pattern 2: displaying ΔE 3.7 to 6.7

Pattern 3 displaying ΔE 6.8 or more

If in pattern 2, ΔE is set as more than 3.6 not more than 6.7; and in pattern 3, ΔE is set as more than 6.7, all the ΔE values can be covered.
Example of classification method setting for 3 patterns of color difference ΔE (in the case of color reproducibility setting of two devices in FIG. 17)

Pattern 1:

device A: displaying ΔE 3.6 or less
device B: displaying ΔE 6.8 or more

Pattern 2:

device A: displaying ΔE 6.8 or more
device B: displaying ΔE 3.6 or less

Pattern 3:

device A: displaying ΔE 6.8 or more
device B: displaying ΔE 6.8 or more
Example of default thumbnail display ON/OFF setting Pattern 1-Pattern 3: OFF displaying (no display)

Image is ON (display)<

### <Additionally Required Setting for Detailed Display (FIGS. 14 and 18>

Example of Image area Designation

x-coordinate: displaying 700-800

y-coordinate: displaying 100-175
Example of default Detailed display ON/OFF setting

Pattern 1-Pattern 2: OFF (no display)

Pattern 3: Image area Designation is ON (display)

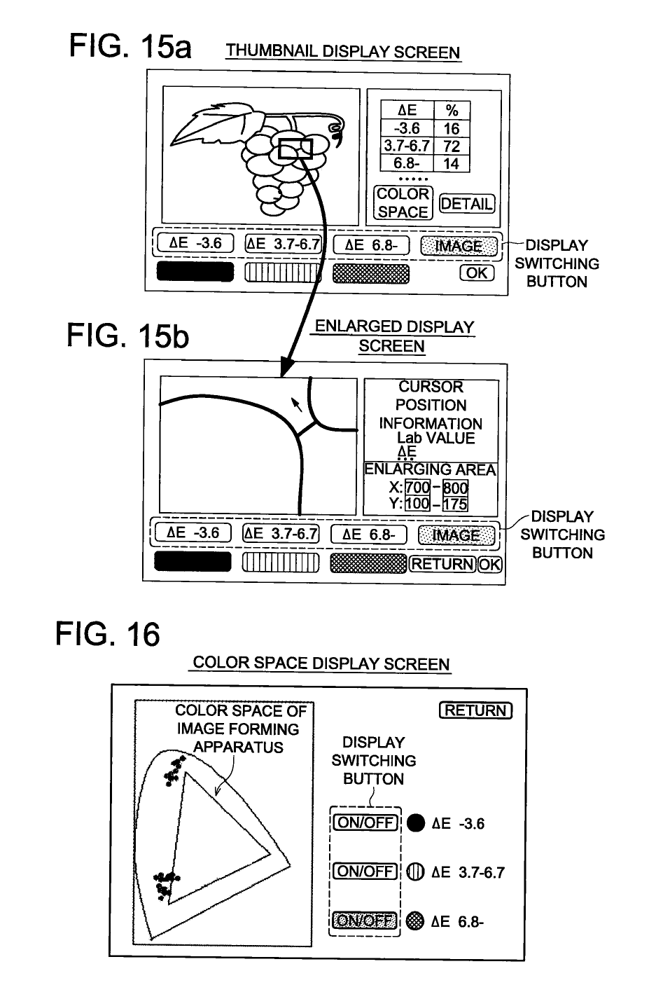

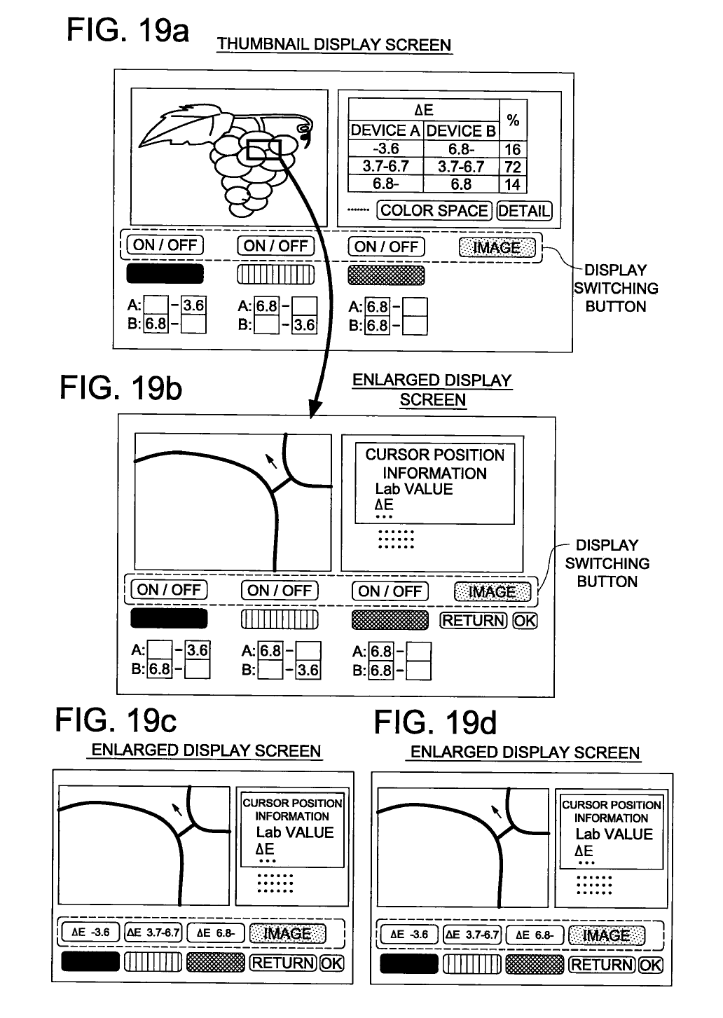

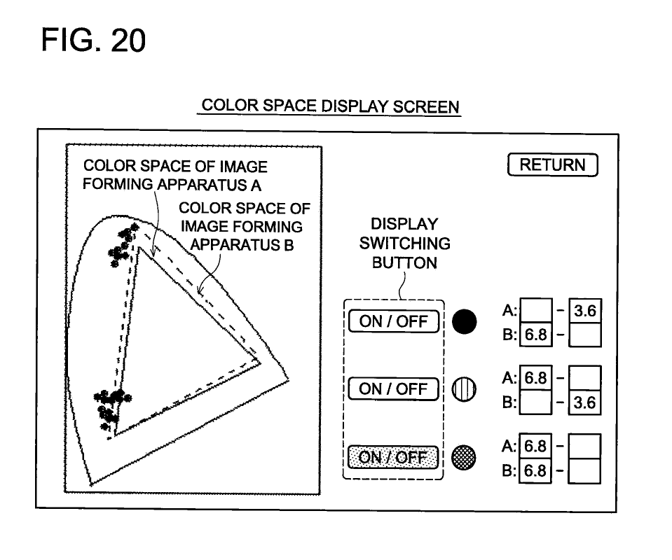

Although, in the enlarged display screens of FIGS. 15b and 19b, the enlarged image area is displayed according to the above image area designation, the enlarged area may be automatically set for the enlarged display. The default enlarged display is also displayed with the same setting as the default thumbnail display, however, it may be enabled to set separately for the enlarged display.

<Additionally Required Setting for Color Space Display of FIGS. 16 and 20>
Example of default Thumbnail display ON/OFF setting

Pattern 1-Pattern 2: OFF (no display)

Pattern 3: ON (display)

After the setting of display method (S808), thumbnail display (S809) is executed.

(Thumbnail Display)

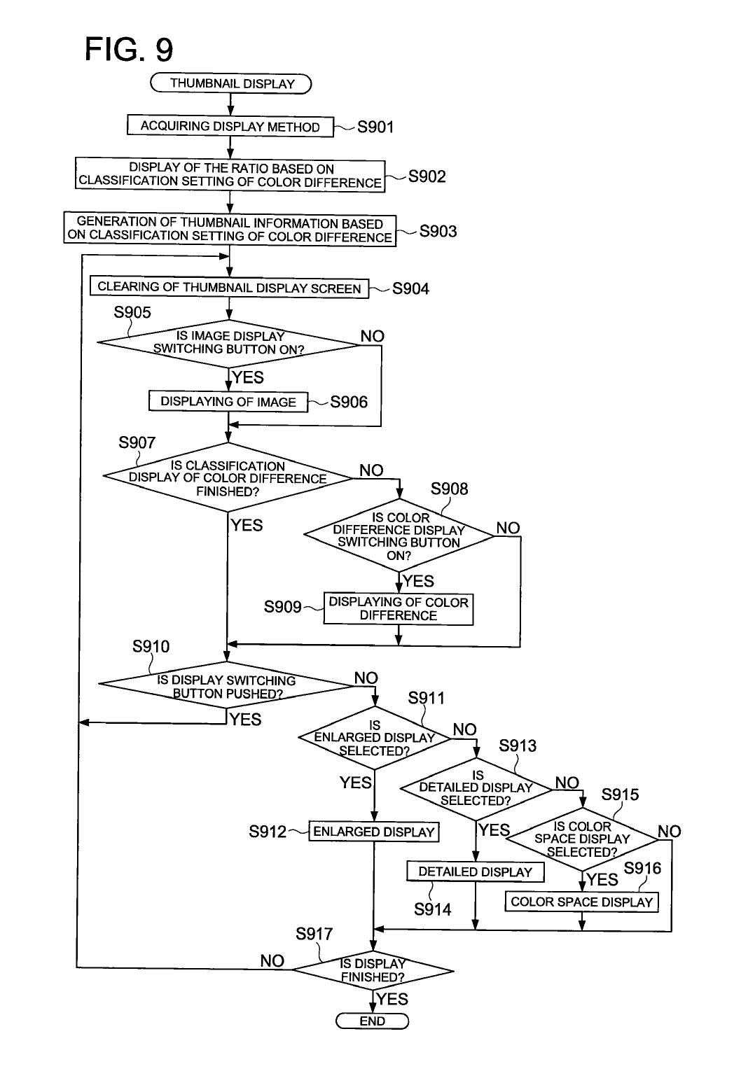

FIG. 9 shows the procedure of thumbnail display for displaying the color reproducibility difference.

In the thumbnail display, first acquires the display method (S901) having been set by the display method setting (S808). Then, based the classification setting of color difference, calculates each ratio of 3 patterns of color difference ΔE in the total area, and displays by text (S902). Similarly, generates the thumbnail information of 3 patterns of color difference ΔE (S903).

Next, by clearing the thumbnail display screen (S904), initializes the screen. In the case where the image display switching is ON (S905: YES), displays the image on the thumbnail display screen (S906). If the display for the pattern of color difference ΔE classification is not executed (S907: NO), confirms the display setting of pattern n, and in the case where the display switching is ON (S908: YES), displays the color difference of pattern n with the display method designated in the display method setting, on the thumbnail display screen. (S909)

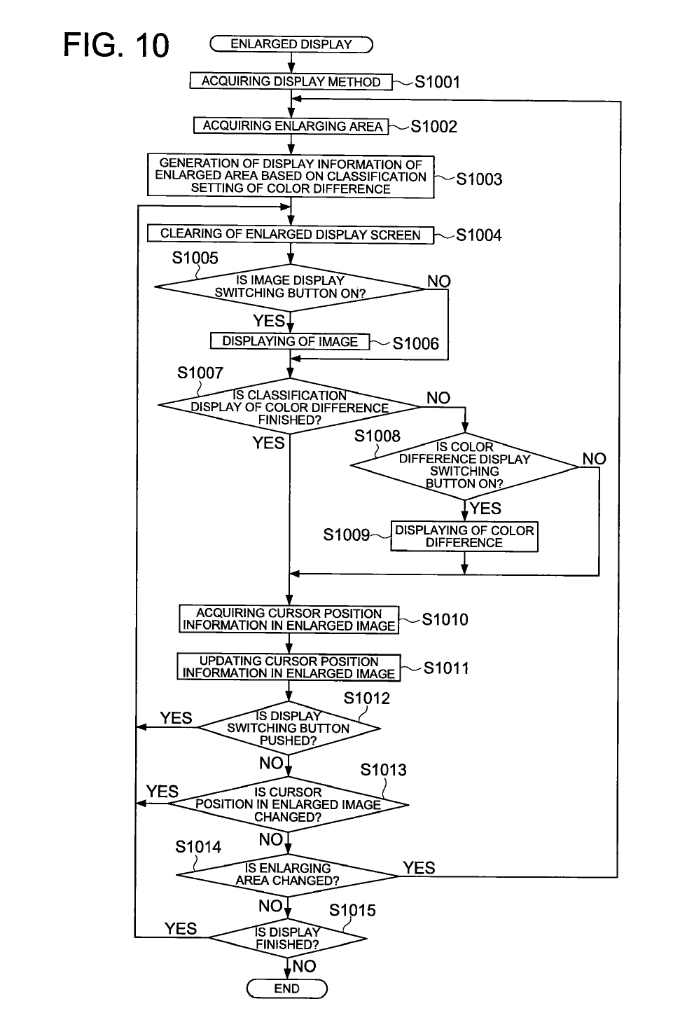

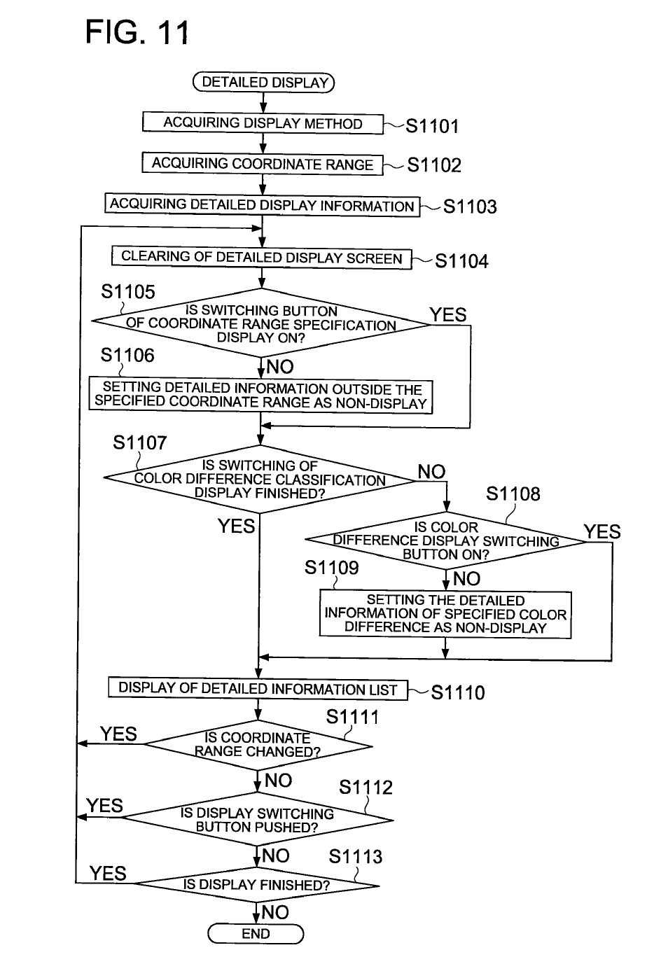

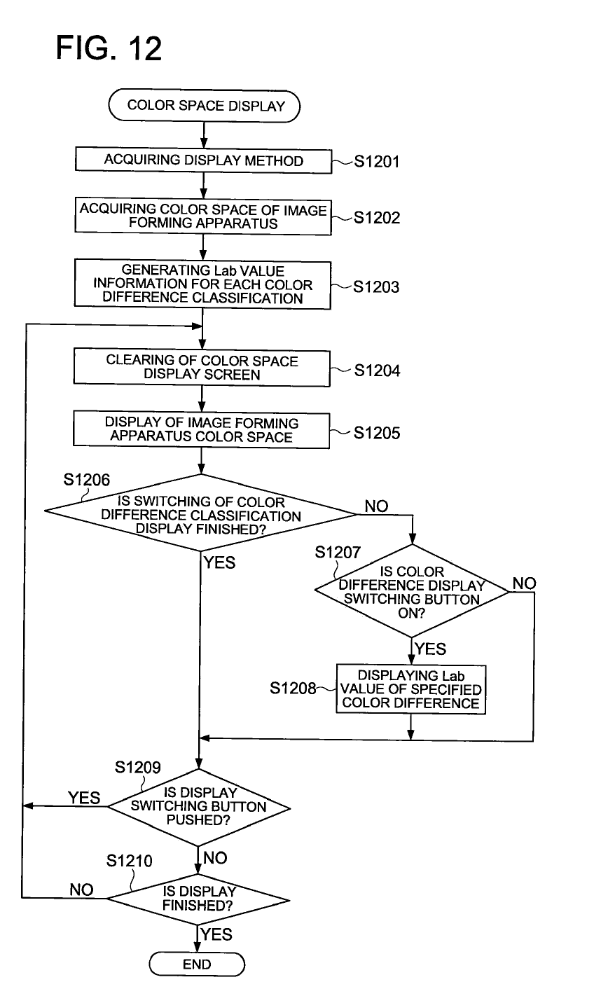

In the case where the display switching button is pushed (5910: YES), returns to the step of clearing the thumbnail display screen (S904). In the case where the enlarged display is selected (S911: YES), the enlarged display (S912) is executed. Flow chart of the enlarged display is shown in FIG. 10. In the case where the detailed display is selected (S913: YES), the detailed display (S914) is executed. Flow chart of the detailed display is shown in FIG. 11. In the case where the color space display is selected (S915: YES), the color space display (S916) is executed. Flow chart of the color space display is shown in FIG. 12. In the case where the display termination is selected (S917: YES), the thumbnail display is terminated.

(Enlarged Display)

FIG. 10 shows the procedure of displaying the difference of color reproducibility.

In the enlarged display, first acquires the display method (S1001) having been set by the display method setting (S808). Then, acquires the area for enlarged display (S01002), and generates the display information for the 3 patterns of color difference ΔE in the area (S1003).

Next, by clearing the thumbnail display screen (S1004), initializes the screen. In the case where the image display switching is ON (S1005: YES), displays the image on the enlarged display screen (S1006). If the display for the pattern of color difference ΔE classification is not executed (S1007: NO), confirms the display setting of pattern n, and in the case where the display switching is ON (S1008: YES), displays the color difference of pattern n with the display method designated in the display method setting, on the enlarged display screen (S1009).

Next, acquires the cursor position information in the enlarged display screen (S1010). Then, text displayed is the Lab value and color difference ΔE at the cursor position (S1011).

In the case where the display switching button is pushed (S1012: YES), returns to the step of clearing the enlarged display screen (S1004). Also in the case where the cursor position in the enlarged image is changed (S1013: YES), returns to the step of clearing the enlarged display screen (S1004). In the case where the enlarged display area is changed (S1014: YES), returns to the step of acquiring the area for enlarged display (S1002). In the case where the display termination is selected (S1015: YES), the enlarged display is terminated.

(Detailed Display)

FIG. 11 shows the procedure of detailed display of the difference in color reproducibility.

In the detailed display, first acquires the display method (S1101) having been set by the display method setting (S808). Then, acquires the coordinate range for the detailed display (S1102), and acquires the detailed display information for the color difference ΔE in the total image area (S1103).

Next, by clearing the detailed display screen (S1104), initializes the screen. In the case where the image display switching is not ON (S1105: NO), based on the acquired detailed display information (S1103), sets the detailed information outside the specified coordinate range to be non-display (S1106). If the display for the pattern of color difference ΔE classification is not executed (S1107: NO), confirms the display setting of pattern n, and in the case where the display switching is not ON (S1108: NO), sets the specified detailed information of the classification pattern to be non-display (S1109). Then, displays the detailed information excluding the non-display part (S1110).

In the case where the coordinate range is changed (S1111: YES), returns to the step of clearing the detailed display screen (S1104). In the case where the display switching button is pushed (S1112: YES), returns to the step of clearing the detailed display screen (S1104). In the case where the display termination is selected (S1113: YES), the detailed display is terminated.

(Color Space Display)

FIG. 12 shows the procedure of color space display of the difference in color reproducibility.

In the color space display, first acquires the display method (S1201) having been set by the display method setting (5808). Then, acquires the color space of the image forming apparatus to be displayed of color space (S1202), and acquires the Lab information for each 3 patterns the color difference ΔE to be displayed (S1203).

Next, by clearing the color space display screen (S1204), initializes the screen. If the display for the pattern of color difference ΔE classification is not executed (S1206: NO), confirms the display setting of pattern n, and in the case where the display switching is ON (S1207: YES), displays the distribution of Lab values of pattern n with the display method designated in the display method setting, on the color space display screen (S1208).

In the case where the display switching button is pushed (S1209: YES), returns to the step of clearing the color space display screen (S1204). In the case where the display termination is selected (S1210: YES), the color space display is terminated.

Hereinafter, the specific configurations of the screen to be displayed by the above-mentioned flows are described.

FIGS. 13a-16 show the examples of displaying the color reproducibility in the case of image formation with certain outputting conditions.

FIGS. 13a-13d are the screens for thumbnail display of the color difference, and images or each pattern are displayed on the screens by pushing the display switching button. FIG. 13a displays only the image, FIG. 13b displays the patterns 1 and 3, FIG. 13c displays pattern 3 and the image, and FIG. 13d displays the patterns 1-3. By displaying with the arbitral combinations of the image and the patterns, it is enabled to surely determine whether required color reproducibility can be attained.

FIG. 14 is a detail display screen displayed when “DETAIL” button in the thumbnail display screens of FIGS. 13a-13d is pressed, where the color differences and Lab values in the predetermined coordinate are displayed. By confirming the difference of the color difference in detail, it is enabled to surely determine whether required color reproducibility can be attained.

FIG. 15b is an enlarged display screen displayed when the area for displaying image is specified in the thumbnail display screens of FIG. 15a. By confirming the difference of the color difference in detail, it is enabled to surely determine whether required color reproducibility can be attained.

FIG. 16 is a color space display screen displayed when “COLOR SPACE” button in the thumbnail display screens of FIGS. 13a-13d is pressed (the color space can be displayed in planar way or in stereoscopic way), where Lab and the color space of the image forming device can be compared. By confirming the difference of the color difference in detail, it is also enabled to surely determine whether required color reproducibility can be attained.

Further, in the case of comparing the color reproducibility of plural image forming devices, by obtaining the print image data L′a′b′ for each image forming device, and calculating each color difference ΔE from the image data Lab, the color reproducibility with plural outputting conditions can be displayed.

FIGS. 17-20 show examples of displaying the color reproducibility of the images formed with plurality of outputting conditions.

FIG. 17 is a screen to display the difference of the color difference by thumbnail display, wherein by pressing the display switching button, images or the patterns of plural image forming devices are displayed. By comparing the difference of the color difference for each image forming device, it is enabled to easily determine which image forming device is to be selected for obtaining the required color reproducibility.

FIG. 18 is a detail display screen displayed when “DETAIL” button in the thumbnail display screens of FIG. 17 is pressed, where the color differences of the plurality of image forming devices in the predetermined coordinate and Lab values are numerically displayed. By comparing the difference of the color difference for each image forming device, it is enabled to surely determine which image forming device is to be selected for obtaining the required color reproducibility.

FIGS. 19b-19d are enlarged display screens displayed when “DETAIL” button in the thumbnail display screens of FIG. 19a is pressed, where FIG. 19b is a screen to concurrently display the color differences of the plural image forming devices, FIGS. 19c-19d are screens to separately show the color difference of each image forming device. By comparing the difference of the color difference for each image forming device in these screens, it is enabled to surely determine which image forming device is to be selected for obtaining the required color reproducibility.

FIG. 20 is a color space display screen displayed when “COLOR SPACE” button in the thumbnail display screens of FIG. 17 is pressed (the color space can be displayed in planar way or in stereoscopic way), where Lab and the color spaces of the plurality of image forming apparatuses (or plurality of image forming devices in cases where the image forming apparatus is loaded with plural types of toners) can be compared. By comparing the difference of the color difference for each image forming device in this screen, it is also enabled to surely determine which image forming device is to be selected for obtaining the required color reproducibility.

Since the requirement for color reproducibility is different by each image data, the difference to be acknowledged in color difference differs by each image data. Therefore, enabling the user setting of the color difference to be displayed, not limiting to the default setting, is preferable.

For example, in the case of comparing the image forming device loading the normal toner with the device loading the vivid toner, the setting of color difference may be changed according to the difference of color reproducibility to be acknowledged. Here, the reproducible color is assumed to be less than ΔE 6.5, and the un-reproducible color is assumed to be ΔE 6.5 or more.

1. The color reproducible by both devices loading the normal toner and the vivid toner:

For both the device loading the normal toner, and the device loading the vivid toner, the item corresponding to ΔE less than 6.5 is displayed.

2. The color reproducible only by the device loading the vivid toner:

For the device loading the normal toner, the item corresponding to ΔE 6.5 or more is displayed, and for the device loading the vivid toner, the item corresponding to ΔE less than 6.5 is displayed.

3. The color reproducible by the device loading the normal toner, but not reproducible by the device loading the vivid toner:

For the device loading the normal toner, the item corresponding to less than ΔE 6.5 is displayed, and for the device loading the vivid toner, the item corresponding to ΔE 6.5 or more is displayed.

4. The color not reproducible by either device loading the normal or vivid toner:

For both the devices loading the normal toner, and the device loading the vivid toner, the item corresponding to ΔE 6.5 or more is displayed.

In addition to the above conditions, by adding the setting condition such that the difference of ΔE between the devices loading the normal toner and the vivid toner is greater than the prescribed value, the more precise color reproducibility can be acknowledged.

As described above, in the present embodiment, converted is the image data to the data in a color space independent from the image forming device (for example, image data Lab), converted is the print image data to the data in the same color space (for example, print image data L′a′b′), and displayed is the color difference ΔE between those data with the thumbnail display screen, the detailed display screen, enlarged display screen and the color space display screen, etc., thus the difference of color reproducibility can be acknowledged. Therefore, by referring to the information provided on the screen, users can select the image forming device having good cost performance.

The present invention is not limited to the above-described embodiment, and can be properly changed to the extent that the image data and the print image data can be compared in the same color space. For example, although in the above embodiment the color difference between the image data Lab and the print image data L′a′b′ is displayed, the color difference of the other color space may be displayed, and the data itself in a color space may be displayed in comparable manner.

According to the image forming apparatus, the printing support method and the printing support program of the present invention, with respect to individual image data, color reproducibility can be confirmed in the case of image formation by prescribed image forming devices. Thus users can easily select the image forming device having good cost performance.

This is because that the image data and the print image data are converted to respective data of a common color space independent from the image forming device, color difference is calculated, and the calculated color difference is displayed on a screen.

The present invention can be applicable to an image forming apparatus, and a printing system including the image forming apparatus.

What is claimed is:

1. An image forming apparatus for printing image data of print subject after converting the image data to print image data dependent on an image forming device, comprising:
a control section which converts the image data to first data in a color space independent from the image forming device by referring to a first conversion table,
converts the print image data to second data in the color space by referring to a second conversion table,
calculates a color difference specified by a difference between the first data and the second data, and
causes a display section to display the calculated color difference.

2. The image forming apparatus of claim 1, wherein the control section causes the display section to display, on a first screen, an image based on the image data with a pattern corresponding to the color difference of each portion of the image.

3. The image forming apparatus of claim 2, wherein the control section causes the display section to numerically display the color difference of each part of the image based on the image data, on a second screen transited from the first screen.

4. The image forming apparatus of claim 2, wherein the control section causes the display section to display the color difference of each part of the image based on the image data, on a third screen transited from the first screen, in such a manner that the color difference can be compared with a reproducible color gamut of the image forming device.

5. The image forming apparatus of claim 1, wherein in cases where the image forming apparatus is loaded with a plurality of types of toner groups, each of whose reproducible color gamut is different from the other, the control section converts the print image data each being dependent on respective type of toner group to the second data of the print image data, and causes the display section to display the color difference for each type of toner groups to be comparable with each other.

6. The image forming apparatus of claim 1, wherein in cases where the image forming apparatus is connected with another image forming apparatus via a communication network, the control section acquires second data in the color space from the another image forming apparatus, or acquires print image data from the another image forming apparatus to convert to second data in the color space, and causes the display section to display the color difference for each image forming apparatus in a comparable manner.

7. A printing support method for a printing system comprising an image forming apparatus which prints an image after converting image data of a print subject to print image data dependent on an image forming device, the method comprising:
a first step of converting the image data to first data in a color space independent from the image forming device by referring to a first conversion table;
a second step of converting the print image data to second data in the color space by referring to a second conversion table,
a third step of calculating a color difference specified by a difference between the first data and the second data, and
a fourth step of displaying the calculated color difference on a display section provided at any of apparatuses composing the printing system.

8. The printing support method of claim 7, wherein in the fourth step, an image based on the image data is displayed on a first screen, with a pattern corresponding to the color difference of each portion of the image.

9. The printing support method of claim 8, wherein in the fourth step, the color difference of each part of the image based on the image data is numerically displayed, on a second screen transited from the first screen.

10. The printing support method of claim 8, wherein in the fourth step, the color difference of each part of the image based on the image data is displayed on a third screen transited from the first screen, in such a manner that the color difference can be compared with a reproducible color gamut of the image forming device.

11. The printing support method of claim 7, wherein in cases where the image forming apparatus is loaded with a plurality of types of toner groups, each of whose reproducible color gamut is different with each other,
in the second step, the print image data each being dependent on the toner group is converted to the second data of the print image data in the color space,
in the third step, the color difference between the first data and the second data for each of the toner groups is calculated, and
in the fourth step, the color difference for each of the toner groups is displayed to be comparable with each other.

12. The printing support method of claim 7, wherein in cases where the printing system comprises a plurality of image forming apparatuses connected via a communication network,
in the second step, the print image data each being dependent on each of the plurality of image forming apparatuses is converted to the second data of the print image data in the color space,
in the third step, the color difference between the first data and the second data for each of the plurality of image forming apparatuses is calculated, and
in the fourth step, the color difference for each of the plurality of image forming apparatuses is displayed to be comparable with each other.

13. A computer-readable storage medium having a program stored therein for causing a computer to execute a printing support procedure for a printing system comprising an image forming apparatus which prints an image after converting image data of a print subject to print image data dependent on an image forming device, the printing support procedure comprising:
a first step of converting the image data to first data in a color space independent from the image forming device by referring to a first conversion table;
a second step of converting the print image data to second data in the color space by referring to a second conversion table,
a third step of calculating a color difference specified by a difference between the first data and the second data, and
a fourth step of displaying the calculated color difference on a display section provided at any of apparatuses composing the printing system.

14. The computer-readable storage medium of claim 13, wherein in the fourth step, an image based on the image data is displayed on a first screen, with a pattern corresponding to the color difference of each portion of the image.

15. The computer-readable storage medium of claim 14, wherein in the fourth step, the color difference of each part of the image based on the image data is numerically displayed, on a second screen transited from the first screen.

16. The computer-readable storage medium of claim 14, wherein in the fourth step, the color difference of each part of the image based on the image data is displayed on a third screen transited from the first screen, in such a manner that the color difference can be compared with a reproducible color gamut of the image forming device.

17. The computer-readable storage medium of claim 13, wherein in cases where the image forming apparatus is loaded with a plurality of types of toner groups, each of whose reproducible color gamut is different with each other,
in the second step, the print image data each being dependent on the toner group is converted to the second data of the print image data in the color space,
in the third step, the color difference between the first data and the second data for each of the toner groups is calculated, and
in the fourth step, the color difference for each of the toner groups is displayed to be comparable with the other.

18. The computer-readable storage medium of claim 13, wherein in cases where the printing system comprises a plurality of image forming apparatuses connected via a communication network,
in the second step, the print image data each being dependent on each of the plurality of image forming apparatuses is converted to the second data of the print image data in the color space,
in the third step, the color difference between the first data and the second data for each of the plurality of image forming apparatuses is calculated, and
in the fourth step, the color difference for each of the plurality of image forming apparatuses is displayed to be comparable with each other.
